(19) United States
(12) Patent Application Publication
(10) Pub. No.: US 2015/0321604 A1
(43) Pub. Date: Nov. 12, 2015

(54) IN-VEHICLE MICRO-INTERACTIONS

(71) Applicant: Ford Global Technologies, LLC, Dearborn, MI (US)

(72) Inventors: Perry Robinson MacNeille, Lathrup Village, MI (US); Yimin Liu, Ann Arbor, MI (US); Oleg Yurievitch Gusikhin, West Bloomfield, MI (US)

(73) Assignee: Ford Global Technologies, LLC, Dearborn, MI (US)

(21) Appl. No.: 14/271,864

(22) Filed: May 7, 2014

(51) Int. Cl. B60Q 9/00; G06N 5/04

(52) U.S. Cl. CPC B60Q 9/00; G06N 5/04

(57) ABSTRACT

A message specifying one or more queries to be provided via a human machine interface (HMI) is received in a vehicle computer. A total estimated cognitive load is determined for an operator of the vehicle based on an estimated current cognitive load and an estimated cognitive load associated with the one or more queries. The one or more queries are provided via the HMI if the total estimated cognitive load is at or below a predetermined threshold.

### BACKGROUND

Mechanisms are currently lacking for conducting real-time or near real-time surveys, interviews, etc. with vehicle occupants such as vehicle drivers. For example, safety concerns weigh against interrupting a driver for a telephone call or the like where the interruption could distract the driver from important vehicle operations. Moreover, some modes of communication are always impractical, e.g., a vehicle driver is virtually never in a position to safely view a display in the vehicle and responded to questions with an input device, e.g., a keypad, touchscreen, etc. Yet further, even if a vehicle driver could be safely and effectively queried and/or surveyed, mechanisms are lacking for identifying vehicles and/or drivers appropriate for particular survey questions.

### DRAWINGS

FIG. 1 is a block diagram of an exemplary system for providing micro-interactions in a vehicle.

FIG. 2 is a diagram of an exemplary process for providing one or more-micro-interactions to a vehicle.

FIG. 3 is a diagram of an exemplary process for handling a micro-interaction in a vehicle.

FIG. 4 is a diagram of an exemplary process for determining whether a micro-interaction should be presented in a vehicle.

FIG. 5 illustrates the Yerkes-Dodson law in the context of the system of FIG. 1.

### DETAILED DESCRIPTION

### System Overview

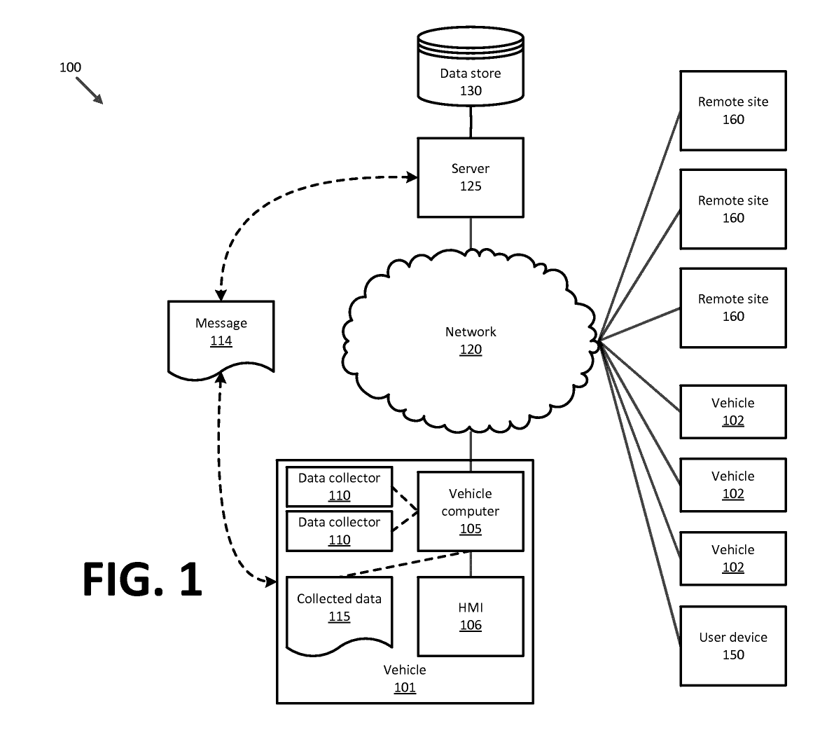

FIG. 1 is a block diagram of an exemplary system 100 for providing micro-interactions in a vehicle 101. The term “micro-interaction” as used herein generally refers to using a human machine interface (HMI) 106, in a computing device such as a vehicle 101 computer 105, to provide one or more outputs requesting one or more responses from a vehicle 101 occupant, and receiving one or more inputs comprising one or more responses. The micro-interaction, e.g., requested responses, may be provided to the vehicle 101 computer 105 in a message or messages from a remote source such as a server 125. Likewise, the one or more responses may be returned to the server 125 in a message 114.

The vehicle 101 may be selected for a micro-interaction by the server 125 according to parameters specified in the server 125 applied to data 115 collected in the vehicle 101. The data 115 may be provided to the server 125 in a message 114. Alternatively or additionally, the server 125 may broadcast a message 114 specifying a micro-interaction to which the vehicle 101 may respond if it satisfies specified criteria for the micro-interaction included in the message 114. Such criteria may include a specific location, weather condition, road condition, etc., relating to the vehicle 101.

### System Elements

A vehicle 101 computer 105 generally includes a processor and a memory, the memory including one or more forms of computer-readable media, and storing instructions executable by the processor for performing various operations, including as disclosed herein. The memory of the computer 105 further generally stores remote data 114 and collected data 115. The computer 105 is configured for communications on a controller area network (CAN) bus or the like, and/or other wire or wireless protocols, e.g., Bluetooth, etc., i.e., the computer 105 can communicate via various mechanisms that may be provided in the vehicle 101. The computer 105 may also have a connection to an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, sensors, etc., including one more user devices 150, data collectors 110. In addition, the computer 105 may be configured for communicating, e.g., with one or more remote servers 125, with the network 120, which, as described below, may include various wired and/or wireless networking technologies, e.g., cellular, Bluetooth, wired and/or wireless packet networks, etc.

A human machine interface (HMI) 106 may be included in or communicatively coupled to the computer 105. The HMI 106 may include various mechanisms for the computer 105 to provide output to, and receive input from, a vehicle 101 operator or other occupant. For example, the HMI 106 may include a display screen, an input device or devices such as elements on the display screen where the display screen is a touchscreen and/or other buttons, knobs, levers, etc. that may be disposed in the vehicle 106. Further, the HMI 106 could include an interactive voice response (IVR) system for providing audio output to a vehicle 101 occupant, as well as for receiving and interpreting verbal responses. Other possible mechanisms in HMI 106 include lights, haptic mechanisms, e.g., embedded in a vehicle 101 seat, steering wheel, etc.

Data collectors 110 may include a variety of devices. For example, various controllers in a vehicle may operate as data collectors 110 to provide data 115 via the CAN bus, e.g., data 115 relating to vehicle speed, acceleration, location, etc., in addition to environmental conditions such mentioned above. Further, sensors or the like, global positioning system (GPS) equipment, etc., could be included in a vehicle and configured as data collectors 110 to provide data directly to the computer 105, e.g., via a wired or wireless connection.

One or more messages 114, described further below, could be provided via the network 120 to the computer 105, possibly using information from a data store 130 associated with a remote server 125. Alternatively or additionally, a remote source providing remote data 114 could be a user device 150, e.g. a smart phone or the like, and/or one or more second vehicles 102, e.g., communicating with the vehicle 101 using a protocol for vehicle-to-vehicle communications, e.g., Dedicated Short Range Communications (DSRC) and/or some other protocol.

As mentioned above, a message 114 may specify a micro-interaction when sent from the server 125 to a vehicle 101 computer 105, and/or may include one or more responses to requests in a micro-interaction, e.g., when sent from the vehicle hundred one computer 105 back to the server 125.

For example, a message 114 from the server 125 may include an identifier for a micro-interaction, a specified query or queries, and/or a specified mode for outputting the query and/or a specified mode for a user to input a response. For example, a query could be a question to be provided via an interactive voice response (IVR) system or the like included in the HMI 106 and/or provided on a visual display included in the HMI 106. Further for example, modes specified for responding to a query could include verbal responses provided to an IVR system, entering a response on a touchscreen or the like included in the HMI 106, selecting buttons, pads, or the like provided in a vehicle 101, e.g., on a steering wheel or the like, and/or use of other elements that could be included in a vehicle 101 HMI 106.

Further for example, a message 114 from a vehicle 101 computer 105 to the server 125 may include the identifier for the micro-interaction, and a response to one or more queries included in the micro-interaction. For example, the response could indicate a user selection of a button, touchscreen element, verbal response to an IVR, etc. The computer 105 could include the received response in a message 114, generally after interpreting the response, e.g., associating a button or touchscreen element with a “yes” or “no,” a numeric value, etc., and/or using speech recognition techniques to interpret verbal responses provided to an IVR, etc.

Collected data 115 may include a variety of data collected in the vehicle 101. Data 115 is generally collected using one or more data collectors 110, and may additionally include data calculated therefrom in the computer 105. For example, data 115 may include a vehicle 101 speed, acceleration, position, e.g., in latitude and longitude geo-coordinates, and/or other operating parameters of the vehicle 101, e.g., such as might be communicated via the vehicle 101 CAN bus. Further, data 115 may relate to environmental conditions, such as an amount of ambient light around the vehicle 101, a presence or absence of precipitation, a type of precipitation, and ambient temperature, etc. In general, collected data 115 may include any data that may be gathered by a collection device 110 and/or computed from such data. In general, a datum 115 is generally associated with a particular point in time. As discussed below, collected data 115 may be provided to the server 125, including for evaluation with respect to parameters stored in the server 125 and/or the data store 130 relating to a survey, i.e., one or more micro-interactions, and/or a micro-interaction. That is, if a datum or data 115 matches a value or range of values specified by a parameter, then the datum or data 115 may indicate that the vehicle 101 providing the datum or data 115 is appropriate for a specified survey and/or micro-interaction.

The network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be one or more computer servers, each generally including at least one processor and at least one memory, the memory storing instructions executable by the processor, including instructions for carrying out various of the steps and processes described herein. The server 125 may include or be communicatively coupled to a data store 130 for storing remote data 115.

Alternatively or additionally, as mentioned above, in addition to the one or more servers 125, a remote source may include one or more computing devices in one or more second vehicles 102 and/or one or more user devices 150. A user device 150 may be any one of a variety of computing devices including a processor and a memory, as well as communication capabilities. For example, the user device 150 may be a portable computer, tablet computer, a smart phone, etc. that includes capabilities for wireless communications using IEEE 802.11, Bluetooth, and/or cellular communications protocols. Further, the user device 155 may use such communications capabilities to communicate via the network 120 and also directly with a vehicle computer 105, e.g., using an in-vehicle communications mechanism, e.g., Bluetooth.

Messages 114 may also be provided to one or more remote sites 160.

### Exemplary Process Flows

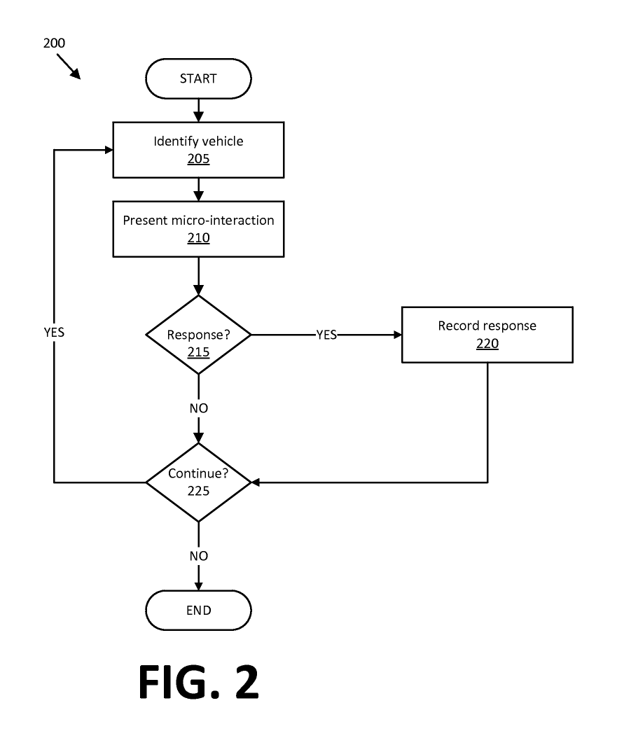

FIG. 2 is a diagram of an exemplary process 200 for providing one or more-micro-interactions to a vehicle 101. The process 200 begins in a block 205, in which the server 125 identifies a vehicle 101 to receive a micro-interaction. For example, the server 125 could be configured to conduct a survey, e.g., what is sometimes referred to as a virtual focus group, by providing queries in one or more micro-interactions to one or more vehicles 101.

The server 125 may use parameters associated with a survey to identify the one or more vehicles 101 to receive the one or more micro-interactions. For example, a survey could be directed to how well a vehicle 101 operator likes a certain feature in a vehicle 101, such as operation of a climate control system when the vehicle 101 encounters precipitation such as rain. To take another example, a survey could be directed to a vehicle 101 operator's interest in a chain of restaurants located in a certain geographic area.

In the foregoing and other examples, the server 125 would use data 115 obtained from one or more vehicles 101 to determine whether a particular vehicle 101 satisfied a parameter or parameters for a survey to be conducted. In the example of the survey directed to a vehicle climate control system, for example, collected data 115 from respective vehicles 101 could be examined by the server 125 to determine which, if any, of the vehicles 101 satisfied parameters for the survey. For example, such parameters could include whether a vehicle 101 was experiencing rain, a make, model, and/or trim level for a vehicle 101, and ambient temperature around the vehicle 101, a geographic area of the vehicle 101, etc. Collected data 115 could indicate values to be compared to respective parameters for a particular vehicle 101, whereupon a vehicle 101 could be selected to participate in a survey and/or receive a micro-interaction based on whether one or more values in the collected data 115 of the vehicle 101 satisfied parameters for the survey and/or micro-interaction stored in the data store 130.

Following the block 205, in a block 210, the server 125 presents a micro-interaction to a vehicle 101 identified and selected as described above with respect to the block 205. That is, a message 114, as discussed above, may specify a query or queries, as well as a mode for response, to be presented via a vehicle 101 HMI 106.

Following the block 210, in a block 215, the server 125 determines whether a response or responses are received from a vehicle 101 that has been provided with a micro-interaction. If yes, then a block 220 is executed next. Otherwise, a block 225 is executed next.

In the block 220, which may follow the block 215, the server 125 records a response or responses received from a vehicle 101 in the data store 130. For example, the server 125 may collect responses from a plurality of vehicles 101.

In the block 225, which may follow either of the blocks 215, 220, the server 125 determines whether to continue the process 200. For example, when no response is received in the block 215, the server 125 may determine whether a sufficient period of time has elapsed to end the process 200, or whether to continue to wait for a response from the vehicle 101. Alternatively or additionally, the server 125 may determine that no further micro-interactions remain to be provided to the vehicle 101 and/or that all requested responses have been received. In any case, if the process 200 should continue, then the process 200 returns to the block 205. Otherwise, the process 200 ends.

Although the process 200 is described herein as being carried out by the server 125, it is to be understood that, as mentioned above, surveys and/or micro-interactions could be provided from other devices, e.g., vehicle 102 computers 105, end user devices 150, etc.

Further, it is to be understood that the server 125 will generally carry out the process 200 contemporaneously with respect to a plurality of vehicles 101, i.e., a plurality of vehicle 101 operators may contemporaneously be provided with micro-interactions as part of a same survey. For example, prior to or as an initial step of the process 200 before the block 205, the server 125 could broadcast a message 114 requesting participation in a survey. The message could request responses specifying certain collected data 115 from each vehicle 101 receiving the broadcast, e.g., a vehicle 101 location, make, model, weather conditions, etc. Based on responses to the initial broadcast message, the server 125 could then select one or more vehicles 101 for a survey in the block 205. Thus, just as with a conventional focus group that features multiple participants physically present in a room, a virtual survey may include multiple participants in a plurality of vehicles 101.

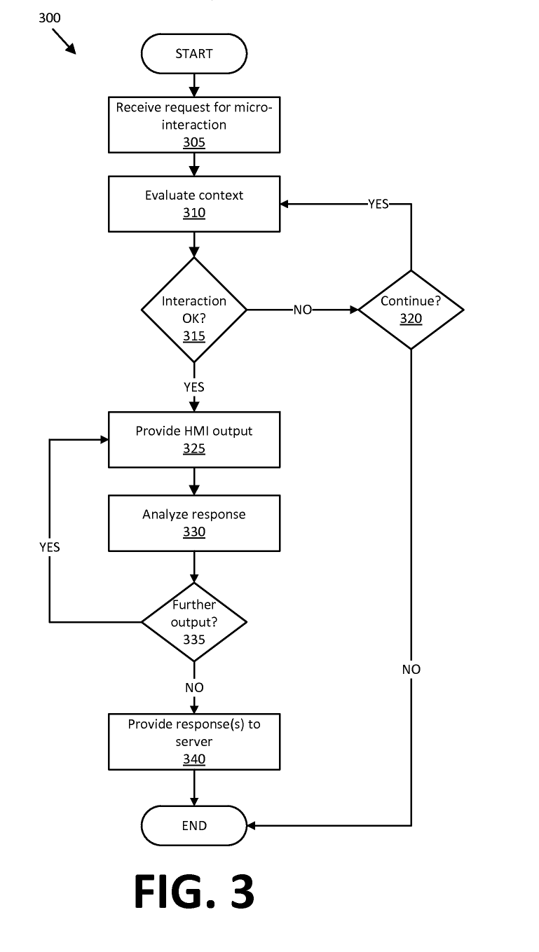

FIG. 3 is a diagram of an exemplary process 300 for handling a micro-interaction in a vehicle 101. The process 300 begins in a block 305, in which the vehicle 101, i.e., in the computer 105, receives a request for a micro-interaction, e.g., in a message 114 as described above.

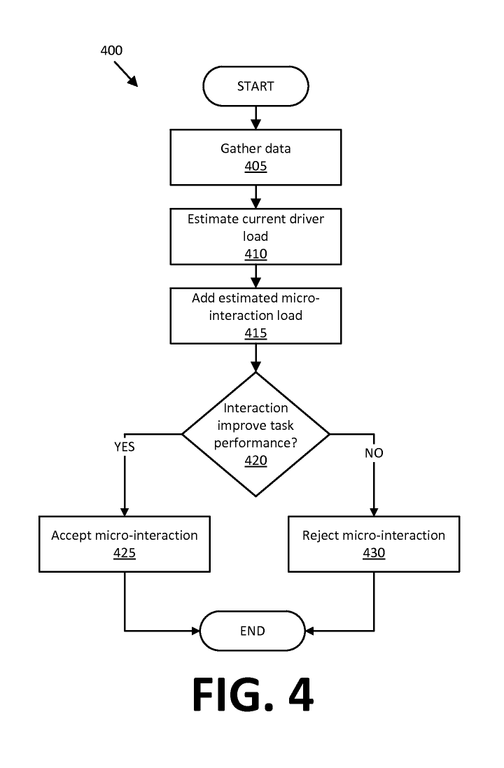

Next, in a block 310, the computer 105 evaluates a context for the micro-interaction in the vehicle 101. An exemplary process for this evaluation is provided below with respect to FIG. 4. In general, the computer 105 uses collected data 115 to determine driving conditions such as a speed, type of road being traveled (e.g., railroad, highway, city street, etc.), road conditions (e.g., slippery, bumpy, etc.), weather conditions (e.g., rain, snow, etc.), in addition or as an alternative to other conditions that may be determined. Further, the computer 105 may use collected data 115 related to vehicle 101 operator behavior, e.g., data collectors 110 can indicate vehicle 101 operator driving patterns such as rates of acceleration, deceleration, responses to potential obstacles, distance maintained from other vehicles, ability to maintain a lane of travel, etc. The computer 105 may further store vehicle 101 operator history, whereupon current operator behavior can be compared to historical operator behavior to determine an operator's likely cognitive load. Yet further, data for determining a cognitive load could be provided by the server 125, one or more second vehicles 102, and/or a user device 150. For example the server 125 could provide data concerning weather, road conditions, etc., as could a second vehicle 102 or the user device 150.

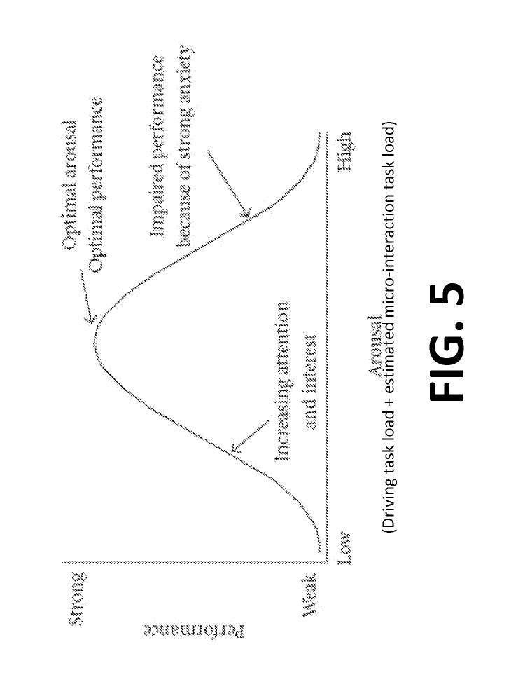

Based at least on some or all of the foregoing, the computer 105 may generate a cognitive model for a vehicle 101 operator indicating a current cognitive load imposed by operating the vehicle 101. The computer 105 may further determine an estimated cognitive load to be imposed by a specified micro-interaction, e.g., based at least in part on a kind of output provided by the micro-interaction, a kind of input required, e.g., verbal versus using a touchscreen, a load imposed by a kind of question being asked, etc. In general, a cognitive load may be computed using a known model, such as the “IVIS DEMAnD” (In-Vehicle Information System Design Evaluation and Model of Attention Demand) model, described in Design Evaluation and Model of Attention Demand (DEMAnD): A Tool for In-Vehicle Information System Designers, Christopher A. Monk et al. Public Road, August 2000, hereby incorporated herein by reference in its entirety. Based on an estimated cognitive load of a vehicle 101 operator when a current cognitive load plus the estimated micro-interaction imposed load are added together, the computer 105 may evaluate whether a micro-interaction is permissible. For example, a rule such as the known Yerkes-Dodson Law, illustrated in the present context in FIG. 5, may be applied to determine whether a vehicle 101 operator's performance will be at or below a predetermined threshold, e.g., representing a possible peak performance, such that a micro-interaction will increase, or at least not diminish, vehicle 101 operator performance in operating the vehicle 101.

Different drivers have different abilities and capacities. Some differences are the result of genetics, age or driving experience and generally do not change, or change very little. Modeling elements such as these can be stored in the server 125 so they are available on any connected vehicle 101 a driver is in. Other factors may be very current, such as emotion, fatigue and weather, and these modelling elements can be stored on the vehicle 101 computer 105 and/or may be provided from collected data 115. Note that, as is known, calibration parameters of the IVIS DEMAnD model and a Yerkes-Dodson curve can be different for different individuals, and can be learned by a machine learning technique incorporating a performance measure and statistical regression methods. e.g., as described in Chapter 6 of National Highway and Transportation Administration document Driver Workload Metrics Project, Task 2 Final Report, DOT Report No. HS 810 635, published November 2006, hereby incorporated herein by reference in its entirety, available to the public from the National Technical Information Service, Springfield, Va. 22161. In a block 315, following the block 310, the computer 105 determines whether the evaluation of the block 310 indicates that a requested micro-interaction is permissible. For example, if an estimated cognitive load is in a range that indicates vehicle 101 operator anxiety is likely increasing, and performance is not peak, e.g., as seen on the right side of the graph in FIG. 5, then a requested micro-interaction may not be permissible. However, if an estimated cognitive load is on the left side of the graph in FIG. 5, i.e., operator performance is below an estimated peak, but operator anxiety is not increasing or at an optimal level for enhancing performance, then a micro-interaction may be permissible. In any case, if the micro-interaction is not permissible, then the process 300 proceeds to a block 320. Otherwise, a block 325 is executed next.

In the block 320, the computer 105 determines whether the process 300 should continue. For example, if a micro-interaction has been determined not to be permissible a certain number of times, if a predetermined amount of time has elapsed since a message 114 was received requesting the micro-interaction but it has not been permissible during that time, etc., the process 300 may end. However, if the computer 105 identifies circumstances under which it should continue to evaluate a context of a requested micro-interaction, then the process 300 returns to the block 310.

In the block 325, which may follow the block 315, the computer 105 provides output specified in the requested micro-interaction, e.g., via the HMI 106.

Next, in a block 330, the computer 105 analyzes a response or responses received with respect to the output provided in the block 325. For example, as stated above, a verbal response to an IVR may be interpreted to determine a word or words spoken by a vehicle 101 operator. Alternatively or additionally, inputs to a touchscreen, knobs, levers, etc. in a vehicle 101 could be interpreted.

Next, in a block 335, the computer 105 determines whether the micro-interaction will include any further response via the HMI 106. If so, the process 300 returns to the block 325. Otherwise, a block 340 is executed next.

In the block 340, the computer 105 creates and sends a message 114 to the server 125 including a response or responses provided as part of a micro-interaction.

Following the block 340, the process 300 ends. However, it will be understood that a survey may include a plurality of micro-interactions. Therefore, the process 300 may be executed one time or more than one time as part of a survey.

FIG. 4 is a diagram of an exemplary process 400 for determining whether a micro-interaction should be presented in a vehicle 101. The process 400 begins in a block 405, in which the computer 105 obtains collected data 115 related to the current operating condition or conditions of the vehicle 101, e.g., collected data 115 as discussed above.

Next, in a block 410, the computer 105 estimates a current cognitive load on a vehicle 101 operator.

Following the block 410, in a block 415, the computer 105 estimates an additional cognitive load likely to be imposed on the vehicle 101 operator by a requested micro-interaction.

Following the block 415, in a block 420, the computer 105, based on the estimated cognitive loads of the blocks 410, 415 determines whether a proposed micro-interaction will improve, or at least not degrade, vehicle 101 operator task performance, e.g., driving performance. If yes, a block 425 is executed next. Otherwise, a block 430 is executed next.

In the block 425, which may follow the block 420, the computer 105 rejects a proposed micro-interaction. For example, in the context of the process 300 above, the block 315 would proceed to the block 320. The process 400 ends following the block 425.

In the block 430, which may follow the block 420, the computer 105 excepts a proposed micro-interaction. For example, in the context of the process 300 above, the block 315 would proceed to the block 325. The process 400 ends following the block 430.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising a computer in a vehicle, the computer comprising a processor and a memory, wherein the computer is configured to:
receive a message specifying one or more queries to be provided via a human machine interface (HMI) in the vehicle;
determine a total estimated cognitive load for an operator of the vehicle based on an estimated current cognitive load and an estimated cognitive load associated with the one or more queries; and
provide the one or more queries via the HMI if the total estimated cognitive load is at or below a predetermined threshold.

2. The system of claim 1, wherein the computer is further configured to obtain a response to the one or more queries, and provide the response in a message to a remote server.

3. The system of claim 1, wherein the predetermined threshold is determined according to the Yerkes-Dodson Law.

4. The system of claim 1, wherein the message further specifies a mode for each of the one or more queries.

5. The system of claim 4, wherein the mode is selected from the group consisting of a verbal mode, a visual mode, and a haptic mode.

6. The system of claim 1, wherein the computer is further configured to determine the estimated current cognitive load based at least in part on data collected in the vehicle related to at least one of vehicle performance and driver performance.

7. The system of claim 1, wherein the computer is further configured to determine the estimated current cognitive load based at least in part on data received from a remote computer via a network.

8. The system of claim 1, wherein the computer is further configured to determine the estimated cognitive load associated with the one or more queries.

9. A system, comprising a computer comprising a processor and a memory, wherein the computer is configured to:
receive data, via a network, from each of a plurality of vehicles;
use the data to select at least some of the vehicles to receive one or more queries; and
send the one or more queries to the selected vehicles.

10. The system of claim 9, wherein the computer is further configured to receive responses to the queries.

11. The system of claim 9, wherein each of the queries includes at least one micro-interaction, each micro-interaction in one of the queries specifying at least one input and at least one output with respect to the query.

12. The system of claim 11, wherein at least some micro-interactions in the queries specify at least one of a mode for outputting the query and a mode for a user to input a response.

13. A method, comprising:
receiving a message specifying one or more queries to be provided via a human machine interface (HMI) in a vehicle;
determining a total estimated cognitive load for an operator of the vehicle based on an estimated current cognitive load and an estimated cognitive load associated with the one or more queries; and
providing the one or more queries via the HMI if the total estimated cognitive load is at or below a predetermined threshold.

14. The method of claim 13, further comprising obtaining a response to the one or more queries, and provide the response in a message to a remote server.

15. The method of claim 13, wherein the predetermined threshold is determined according to the Yerkes-Dodson Law.

16. The method of claim 13, wherein the message further specifies a mode for each of the one or more queries.

17. The method of claim 16, wherein the mode is selected from the group consisting of a verbal mode, a visual mode, and a haptic mode.

18. The method of claim 13, further comprising determining the estimated current cognitive load based at least in part on data collected in the vehicle related to at least one of vehicle performance and driver performance.

19. The method of claim 13, further comprising determining the estimated current cognitive load based at least in part on data received from a remote computer via a network.

20. The method of claim 13, further comprising determining the estimated cognitive load associated with the one or more queries.
